(19) United States
(12) Patent Application Publication
(10) Pub. No.: US 2014/0151391 A1
(43) Pub. Date: Jun. 5, 2014

(54) APPARATUS FOR MANAGING SHELF CONTROL INFORMATION FOR MULTI-VENDING MACHINE AND METHOD THEREOF

(71) Applicant: LOTTE ALUMINIUM CO., LTD., Seoul (KR)

(72) Inventor: Sung Chul JO, Bucheon-si (KR)

(73) Assignee: LOTTE ALUMINIUM CO., LTD., Seoul (KR)

(21) Appl. No.: 14/089,666

(22) Filed: Nov. 25, 2013

(30) Foreign Application Priority Data
Dec. 4, 2012 (KR) 10-2012-0139434

(51) Int. Cl. G07F 11/38

(52) U.S. Cl. CPC G07F 11/38
USPC 221/1; 221/13

(57) ABSTRACT

Disclosed are an apparatus for managing shelf control information for a multi-vending machine and a method thereof. The apparatus includes a shelf recognizing unit for recognizing whether a shelf is mounted; a column detecting unit for detecting whether a column mounted on the shelf exists; a column kind detecting unit for detecting a kind of columns; and a control unit for generating product control information based on information about the shelf, the column and the kind of columns detected by the shelf recognizing unit, the column detecting unit and the column kind detecting unit and storing the product control information in a memory.

### BACKGROUND

The present invention relates to a management of shelf control information for a multi-vending machine and a method thereof, and more particularly, to an apparatus for managing shelf control information for a multi-vending machine capable of automatically recognizing shelves, product columns and the kinds of product column when power is supplied in order to conveniently recognize product information and a method thereof.

In general, a vending machine, which is operated in an unmanned sale scheme, possesses various products, such as coffee, cigarettes, snacks or books, for sale therein and dispenses a product through an outlet to a purchaser who desires to purchase the product when the purchaser selects the product after inserting currency corresponding to the desired product.

Recently, differently from general vending machines, a multi-vending machine for selling various kinds of products through a single machine in an unmanned sale scheme has been proposed.

A multi-vending machine has been disclosed in Korea Patent Unexamined Publication No. 10-2010-0087846 (Published on Aug. 6, 2010; hereinafter, referred to as “related art”).

The related art senses whether a shelf protrudes or not. Thus, it is previously prevented that a basket collides against the shelf so that the vending machine can be prevented from being broken caused when the shelf is not fully input into a product showcase. In addition, products in the showcase can be prevented from falling down from the shelf due to the movement of the machine and the basket accurately moves up and down without any errors. Further, a banner advertisement, which appears and disappears as the basket moves up and down, is provided, so that an observer feels fun, so additional profit may be obtained.

However, according to the related art, the information about kinds of the columns and whether the shelf and the product column exist or not are necessarily required to recognize the product information. In addition, the shelf control information necessary to recognize the product information must be manually set by a manager one by one. This manual work must be performed whenever the shelf information is changed.

In general, since various kinds of products are exhibited in the multi-vending machine for sale, the multi-vending machine must necessarily recognize the product information in order to automatically sell the products by utilizing the product recognizing information as the shelf control information. However, according to the related art, since the product recognizing information must be manually set by a manager one by one, this manual work may be very inconvenient, and in addition, it may be inaccurate to manually input information.

### SUMMARY

Accordingly, it is an object of the present invention to provide an apparatus for managing shelf control information for a multi-vending machine capable of automatically recognizing a shelf, a product column and a kind of columns when the multi-vending machine is powered on, and a method thereof.

It is another object of the present invention to provide an apparatus for managing shelf control information for a multi-vending machine capable of conveniently recognizing product information and a method thereof.

According to one aspect of the present invention, there is provided an apparatus for managing shelf control information for a multi-vending machine. The apparatus includes a shelf recognizing unit for recognizing whether a shelf is mounted; a column detecting unit for detecting whether a column mounted on the shelf exists; a column kind detecting unit for detecting a kind of columns; and a control unit for generating product control information based on information about the shelf, the column and the kind of columns detected by the shelf recognizing unit, the column detecting unit and the column kind detecting unit and storing the product control information in a memory.

According to another aspect of the present invention, there is provided a method of managing shelf control information for a multi-vending machine. The method includes a) detecting existence or nonexistence of a shelf and a column and a kind of columns through a shelf recognizing unit, a column detecting unit and a column kind detecting unit when a power is supplied; b) generating the shelf control information based on information about the existence or nonexistence of the shelf and the column and the kind of column detected in step (a); and c) registering the shelf control information generated in step (b) on a memory.

According to the present invention, when the multi-vending machine is powered on, the existence or nonexistence of a shelf and a column and a kind of columns may be automatically recognized.

In addition, since the shelf control information for recognizing a product is automatically recognized, the management may be very conveniently performed.

### BRIEF DESCRIPTION OF THE DRAWINGS

FIGS. 1A and 1B are schematic perspective views showing a multi-vending machine to which an apparatus for managing shelf control information according to the present invention is applied;

FIG. 2 is a block diagram showing an apparatus for managing shelf control information for a multi-vending machine according to an embodiment of the present invention; and

FIG. 3 is a flowchart illustrating a method of managing shelf control information for a multi-vending machine according to an embodiment of the present invention.

### DETAILED DESCRIPTION OF THE EMBODIMENTS

Hereinafter, the embodiments will be described with reference to the accompanying drawings. In the following description, if detailed description about well-known functions or configurations may make the subject matter of the disclosure unclear, the detailed description will be omitted.

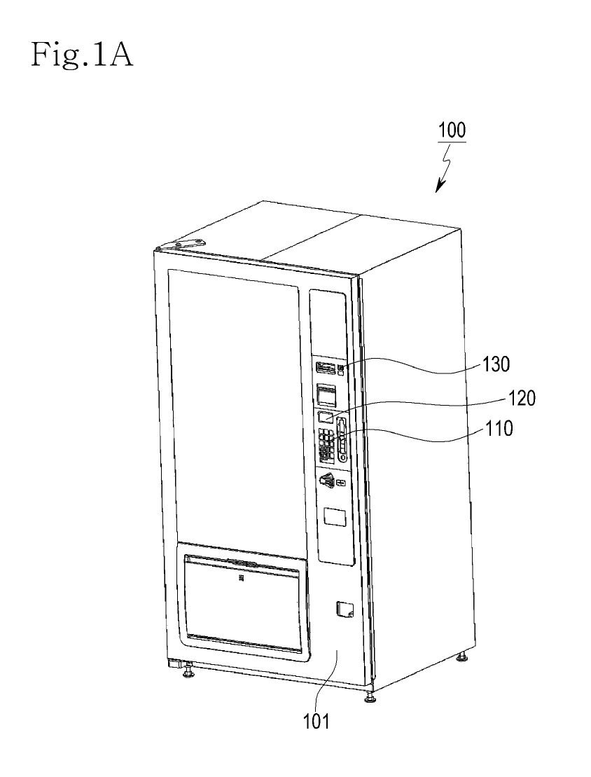

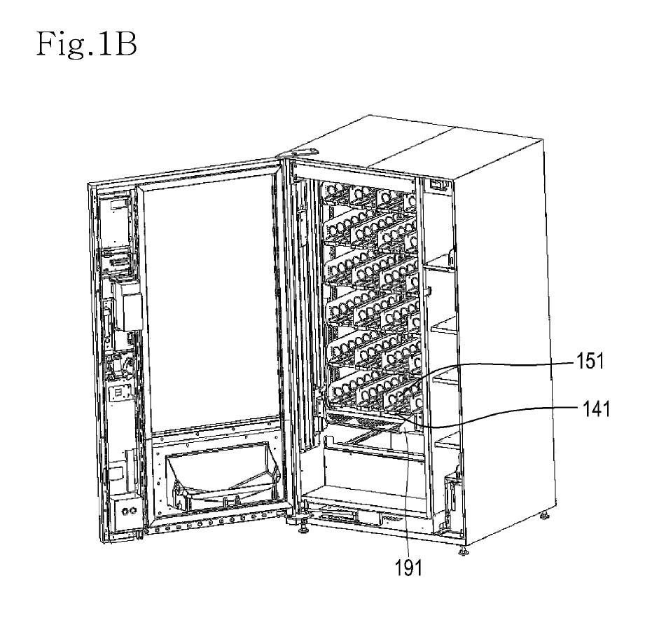

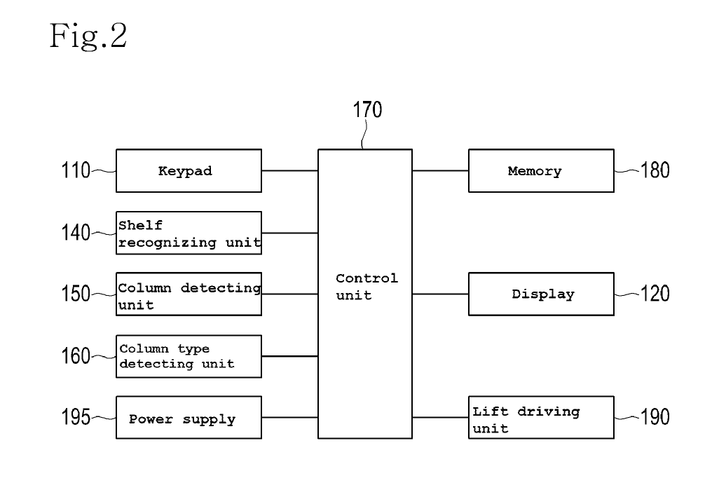

FIGS. 1A and 1B are schematic perspective views showing a multi-vending machine to which an apparatus for managing shelf control information according to the present invention is applied. FIG. 2 is a block diagram showing an apparatus for managing shelf control information for a multi-vending machine according to an embodiment of the present invention. The apparatus for managing shelf control information for a multi-vending machine according to an embodiment of the present invention includes a main body 101, a keypad 110, a display 120, a speaker 130, a shelf recognizing unit 140, a column detecting unit 150, a column type detecting unit 160, a control unit 170, a memory 180, a lift driving unit 190 and a power supply 195.

In the FIGS. 1A and 1B, a shelf 141 may be a showcase in which a plurality of columns 151 is exhibited. The column 151 may be an apparatus in which the products for sale are exhibited and discharges the exhibited products one by one every time that the products are sold. The column is classified as a spiral type or a belt type according to the scheme of discharging a product.

The keypad 110 may be used for selecting a product to purchase the product by a user. The display 120 may include an LCD (Liquid Crystal Display) to display information about a currency input by a user, information about a selected product and shelf control information requested by a manager. The speaker 130 may output an alarm sound or an advertise sound.

The shelf control information may include information about a position of a shelf, existence of a column of a shelf and a column type.

The shelf recognizing unit 140 may recognize whether a shelf is mounted or not, and transfer a shelf detecting signal to the control unit 170 through a harness electrically connected to the control unit 170. The control unit 170 may recognize a position of a shelf based on shelf identifying information included in the shelf detecting signal.

The column detecting unit 150, which detects whether a column mounted on the shelf exists or not, may be mounted on a portion corresponding to a position of a column of a shelf such that a column detecting signal is generated when a column exists.

The column type detecting unit 160 may detect a type of column. The column type detecting unit 160 generates a column type detecting signal only when a column has the spiral type, so that the types of column may be distinguished from each other. For example, when a column exists in a specific shelf, if the shelf type detecting signal is generated, the column is recognized as the spiral type. If the shelf type detecting signal is not generated, the column is recognized as the belt type. A mechanical structure for recognizing a type of column may be formed to allow a spiral column to make contact with a column type detecting terminal of the harness and to prohibit a belt column from making contact with the column type detecting terminal of the harness which electrically transfers the column type detecting signal to the control unit when the column is of the spiral type, so that the column type may be simply identified. Besides the scheme described above, various schemes of identifying a type of column may be implemented.

The control unit 170 generates the shelf control information based on the information about a shelf, a column and a type of column detected through the shelf recognizing unit 140, the column detecting unit 150 and the column type detecting unit 160 and stores the shelf control information in the memory 180. Preferably, the control unit 170 maybe implemented with a control device such as a microprocessor, a controller, a microcomputer or a CPU. More preferably, the control unit 170 controls the product sale based on the generated shelf control information.

The shelf control information is registered on the memory 180 and a control program for selling a product based on the shelf control information is stored in the memory 180. The lift driving unit 190 drives a lift 191 under control of the control unit 170.

Further, the power supply 195 supplies a power to the multi-vending machine or blocks the power supply to the multi-vending machine according to an operation of a power switch by a manager.

According to the apparatus for managing shelf control information for a multi-vending machine according to an embodiment of the present invention, when the multi-vending machine is powered on through the power supply 195, the control unit 170 is initiated and read out the shelf control program stored in the memory 180 so that the control unit 170 controls the entire operation of the multi-vending machine.

For example, the position of the shelf is identified through the shelf recognizing unit 140. The shelf recognizing unit 140 transmits the shelf detecting signal to the control unit 170 through the harness provided for electrically connecting the shelf recognizing unit 140 to the control unit 170. Specifically, when an arbitrary shelf is mounted at a shelf mounting position, the shelf is connected to the harness so that the shelf detecting signal of a corresponding line is transmitted to the control unit 170. In this case, the shelf detecting signal includes the shelf identifying information of denoting which line the shelf detecting signal is generated from, that is, which the shelf is positioned at, so that the control unit 170 easily recognizes the position at which the shelf is positioned.

The harness is an electric connector which is required to electrically connect an automatic control panel (control unit) to a PLC program, a servo motor, various kinds of sensors, and hydraulic pressure or pneumatic equipment in order to operate the automatic control panel used in various fields such as an industrial field, machine equipment or a vehicle.

In other words, the harness may include electric connecting wires provided at the positions of each shelf and the shelf detecting signal, which is generated in the electric connecting wire when a shelf is mounted, is transmitted to the control unit 170. In this case, since ports to which the shelf detecting signals are input are provided, the control unit 170 the control unit 170 may easily recognize the position of the shelf.

If the shelf recognition is completed, it is detected whether a column exists in the recognized shelf.

Conventionally, four or eight columns exist in one shelf. Thus, the control unit 170 must know how many columns exist in the shelf and which positions the columns are placed at in order to utilize the shelf control information when the products are sold.

To this end, the column detecting unit 150 detects a column of the mounted shelf. For example, the column detecting unit 150 is installed at a portion corresponding to the position of a column mounted on the shelf, such that the column detecting signal is generated when the column exists. That is, the maximum number of columns mounted on one shelf may be eight. Since the intervals between the columns are equal to each other, column detecting sensors are installed at eight column positions, so that the columns of a certain shelf may be simply detected. In other words, the eight column detecting sensors detect the existence of the columns at each position, such that the sensors may output the column detecting signals when the columns are detected. Thus, if four columns exist in a shelf, the column detecting signals are generated from only four column detecting sensors. The column detecting signals are grouped according to the shelves and transferred to the control unit 170 through the harness. Thus, the control unit 170 analyzes the column detecting signals transferred in units of shelves so that the control unit 170 recognizes how many columns exist in the shelf. In addition, since the column detecting signals are generated from each sensor, it is possible to identify the positions of the columns.

Next, when a column is detected, a type of the column is detected through the column type detecting unit 160. In this case, the column type detecting unit 160 may easily identify the types of column by using a scheme of detecting only columns of either the spiral or the belt type It is assumed for the purpose of convenient description in the embodiment that the column type detecting signal is generated only when the spiral column is detected. For example, when a column exists and is of the spiral type, the column type detecting unit 160 generates the column type detecting signal and transfers the column type detecting signal to the control unit 170 as described above. Thus, the control unit 170 may know the positions and the number of columns in a shelf and identify the types of column based on the column type detecting signals generated from each column of the shelf. In this case, if a mechanical device for detecting a spiral column is provided to the spiral column such that the spiral detecting signal is generated when the mechanical device is detected by using a sensor, the scheme of generating a column type detecting signal for a spiral column may be easily implemented.

As described above, when a shelf, a position of the shelf, a column and a kind of column are detected, the control unit 170 generates the shelf control information based on the detection information and registers the shelf control information on the memory 180. Consequently, the shelf control information becomes product recognition information.

Then, in the state of standing by to sell products, when a user inserts the currency of a price for a product and selects the product through the keypad 110, the control unit 170 reads out the shelf control information from the memory 180 and extracts the information about the column of the shelf at which the product is placed from the shelf control information. Then, the control unit 170 identifies a type of the detected column and controls the driving device according to the type of the detected column in order to allow the product exhibited on the column to drop down to the lift. The reason for identifying the type of the column is because the schemes of driving a column are different from each other according to the types of column. Since the scheme of controlling a column drive according to a kind of column is the same as that of a conventional multi-vending machine, the detailed description will be omitted.

According to the present invention, when the multi-vending machine is powered on, since the information about a position of a shelf, existence of a column and a kind of column may be recognized and the shelf control information is registered automatically, convenience may be provided to a manger as compared with the previous scheme in which a manager manually inputs information about the information about a position of a shelf, existence of a column and a kind of column.

Specifically, since the shelf control information is generated through the automatic recognizing scheme and stored, the accuracy may be improved as compared with that of the previous scheme in which a manager manually inputs shelf control information.

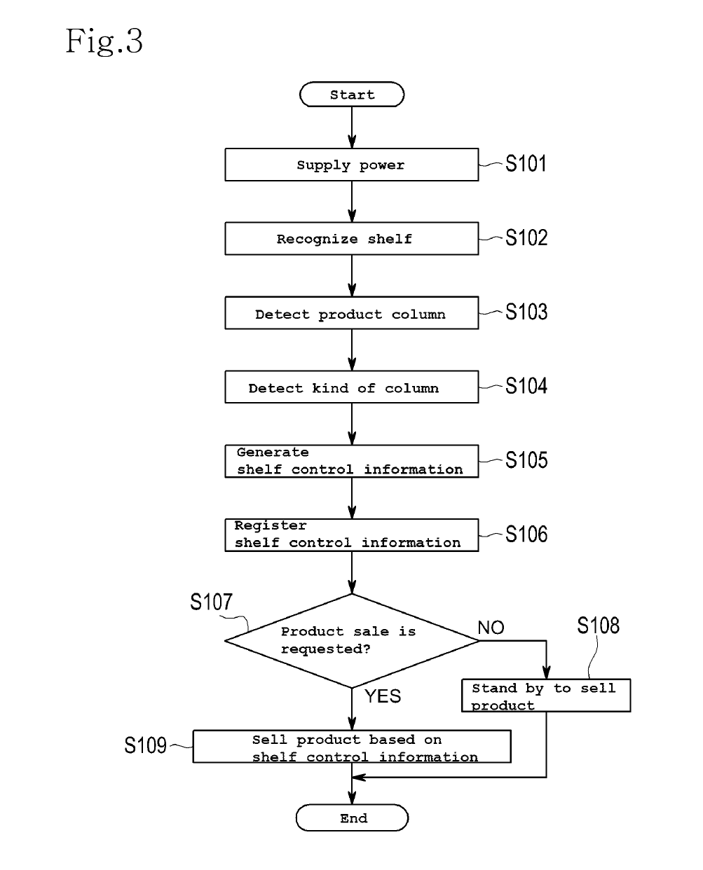

Hereinafter a method of managing shelf control information for a multi-vending machine according to an embodiment of the present invention will be described with reference to FIG. 3.

FIG. 3 is a flowchart illustrating a method of managing shelf control information for a multi-vending machine according to an embodiment of the present invention. In FIG. 3, ‘S’ is a step and a process of generating the shelf control information, which is performed by the control unit 170, is denoted in software.

As shown in FIG. 3, the method of managing shelf control information for a multi-vending machine according to an embodiment of the present invention includes steps S101 to S104 of detecting existence or nonexistence of a shelf, existence or nonexistence of a column and a kind of column through the shelf recognizing unit, the column detecting unit and the column kind detecting unit when a power is supplied; step S105 of generating shelf control information based on the information about the existence or nonexistence of the shelf, the existence or nonexistence of the column and the kind of column detected by the detection; step S106 of registering the shelf control information on the memory; and steps S107 to 109 of controlling a product sale by recognizing product information based on the shelf control information registered on the memory when the product sale is requested after performing the register of the shelf control information.

As described above, according to the method of managing shelf control information for a multi-vending machine according to an embodiment of the present invention, when the power is supplied in step S101, the shelf position information is detected through the shelf recognizing unit 140, so that the shelf position is recognized.

Then, it is detected in step S103 whether a column exists in the recognized shelf or not. That is, positions of the columns at the shelf are detected through the column detecting unit 150.

After the positions of the columns are detected, it is detected in step S104 whether the columns are spiral type or belt type.

In addition, the shelf control information is generated based on the information about the position of the detected shelf, the information about the columns of the detected shelf and the information about the types of column in step S105, and is registered on the memory 180 in step S106.

For example, when a user of the multi-vending machine selects a product, it must be known which shelf and column the product is located at and in addition, what kind the column is of, such that the column can be exactly driven.

According to the related art, since a manager manually sets the information about the positions of the shelf and columns and the information about the types of column ever time that the shelf information is changed, it is very inconvenient and inaccurate for the manager to perform the setting work. However, according to the present invention, since the information about the positions of the shelf, the information about columns of the shelf and the information about the types of column are automatically recognized, the convenience and accuracy are improved.

In the state that the shelf control information is registered on the memory through the above-described process, it is identified in step S107 whether the user requests to sell the product. If the selling request does not occur, the state of standing by to sell products is maintained in step S108. To the contrary, if occurs, the column is controlled based on the shelf control information registered on the memory so that the product is sold.

According to the present invention, when the multi-vending machine is powered on, since the information about a position of a shelf, existence of a column and a kind of column may be recognized and the shelf control information is registered automatically, convenience may be provided to a manger as compared with the previous scheme in which a manager manually inputs information about the information about a position of a shelf, existence of a column and a kind of column.

Specifically, since the shelf control information is generated through the automatic recognizing scheme and stored, the accuracy may be improved as compared with that of the previous scheme in which a manager manually inputs shelf control information.

Although an exemplary embodiment of the present invention has been described for illustrative purposes, those skilled in the art will appreciate that various modifications, additions and substitutions are possible, without departing from the scope and spirit of the invention as disclosed in the accompanying claims. In addition to variations and modifications in the component parts and/or arrangements, alternative uses will also be apparent to those skilled in the art.

What is claimed is:

1. An apparatus for managing shelf control information for a multi-vending machine, the apparatus comprising:
a shelf recognizing unit for recognizing whether a shelf is mounted;
a column detecting unit for detecting whether a column mounted on the shelf exists;
a column kind detecting unit for detecting a kind of columns; and
a control unit for generating product control information based on information about the shelf, the column and the kind of columns detected by the shelf recognizing unit, the column detecting unit and the column kind detecting unit and storing the product control information in a memory.

2. The apparatus of claim 1, further comprising:
a power supply for supplying a power to the multi-vending machine or blocking the power supplied to the multi-vending machine according to power switch manipulation by a manager,
wherein the control unit generates the product control information when the power is supplied to the control unit by the power supply.

3. The apparatus of claim 1, wherein the shelf recognizing unit transfers a shelf detecting signal to the control unit through a harness electrically connected to the control unit when the shelf is mounted, and
the control unit recognizes a location of the shelf based on shelf identifying information included in the shelf detecting signal.

4. The apparatus of claim 1, wherein the column detecting unit is mounted on a portion corresponding to a location of the column of the shelf to generate a column detecting signal when the column exists.

5. The apparatus of claim 1, wherein the column kind detecting unit generates a column kind detecting signal only when the kind of columns is a spiral, so that the kind of columns is detected.

6. A method of managing shelf control information for a multi-vending machine, the method comprising:
a) detecting existence or nonexistence of a shelf and a column and a kind of columns through a shelf recognizing unit, a column detecting unit and a column kind detecting unit when a power is supplied;
b) generating the shelf control information based on information about the existence or nonexistence of the shelf and the column and the kind of column detected in step (a); and
c) registering the shelf control information generated in step (b) on a memory.

7. The method of claim 6, further comprising: d) controlling a product sale by recognizing product information based on the shelf control information registered on the memory when the product sale is requested after step (c).
